(19) United States
(12) Patent Application Publication
(10) Pub. No.: US 2008/0237901 A1
(43) Pub. Date: Oct. 2, 2008

(54) Water Purifying Apparatus

(76) Inventor: Takeo Senoo, Okayama (JP)

Correspondence Address: BIRCH STEWART KOLASCH & BIRCH, PO BOX 747, FALLS CHURCH, VA, 22040-0747, US

(21) Appl. No.: 10/594,675

(22) PCT Filed: Jan. 27, 2005
(86) PCT No.: PCT/JP05/01060

§ 371 Date: Sep. 28, 2006

(30) Foreign Application Priority Data
Mar. 31, 2004 (JP) 2004-103324

(51) Int. Cl. B01F 3/04

(52) U.S. Cl. 261/76; 210/198.1; 261/DIG. 75

(57) ABSTRACT

A water purifying apparatus includes a tubular portion having an inlet for receiving water and an outlet for emitting the water, and a nozzle portion disposed inside the tubular portion to allow the water flowing through the tubular portion to pass therethrough. The nozzle portion has a nozzle opening for discharging the water toward the outlet. The tubular portion is provided with air supply means for mixing air taken in from outside the tubular portion with the water discharged from the nozzle opening. The nozzle opening has a shape defined by one line segment or a combination of a plurality of line segments.

### TECHNICAL FIELD

The present invention relates to a water purifying apparatus for purifying water in a closed water area such as a pond, a lake, a marsh or a pool, or in a flowing water area such as a river or an irrigation channel.

### BACKGROUND ART

Examples of a conventional water treating apparatus include the one disclosed in Japanese Patent Laying-Open No. 08-155430 and the one disclosed in Japanese Patent Laying-Open No. 2002-066549.

The apparatus described in Japanese Patent Laying-Open No. 08-155430 is provided with an intermediate pipeline portion mixing air introduced from outside with water flowing inside, in an intermediate portion of a pipeline. The apparatus is provided with a nozzle in a rear portion of the pipeline, and the pipeline changes its direction in a portion ahead of the nozzle. Further, the apparatus is provided with a venturi tube structure at a position downstream of the nozzle. This apparatus is designed to increase the amount of oxygen contained in water by introducing air from outside via a through-hole provided in the venturi tube structure and mixing the air with water discharged from the nozzle.

The apparatus described in Japanese Patent Laying-Open No. 2002-066549 includes a tubular main body, a nozzle provided within the tubular main body, and air supply means for mixing air with water discharged from the nozzle. Two types of the air supply means are disclosed: one is a hole provided in the tubular main body, and the other is a tube extending from outside the tubular main body to close to an outlet of the nozzle.

Patent Document 1: Japanese Patent Laying-Open No. 08-155430

Patent Document 2: Japanese Patent Laying-Open No. 2002-066549

### DISCLOSURE OF THE INVENTION

### Problems to be Solved by the Invention

Both apparatuses disclosed in the above two documents have a function of mixing air with water discharged from a nozzle. In such a structure, air can sufficiently be mixed with water when the nozzle has a small opening. However, when a larger nozzle is employed to increase the amount of water to be treated, the flow of the discharged water becomes wider, causing a problem that air cannot fully be mixed with the water just by being introduced close to the water.

One object of the present invention is to provide a water purifying apparatus capable of sufficiently mixing air with discharged water even when a larger nozzle is employed.

### Means for Solving the Problems

In order to achieve the above object, a water purifying apparatus in accordance with the present invention includes a tubular portion having an inlet for receiving water and an outlet for emitting the water, and a nozzle portion disposed inside the tubular portion to allow the water flowing through the tubular portion to pass therethrough. The nozzle portion has a nozzle opening for discharging the water toward the outlet. The tubular portion is provided with air supply means for mixing air taken in from outside the tubular portion with the water discharged from the nozzle opening. The nozzle opening has a shape defined by one line segment or a combination of a plurality of line segments.

### EFFECTS OF THE INVENTION

According to the present invention, since the water discharged from the nozzle opening flows in the shape of a flat plate, the water has an increased surface area per volume, facilitating the mixing of the air introduced close to the water by the air supply means with the water. Consequently, the mixing of the air with the water can be performed without any difficulty even when a larger nozzle is employed to increase the amount of water flow. Therefore, the amount of oxygen contained in the water passing through the tubular portion can be increased, and the water can be purified as a result.

### BRIEF DESCRIPTION OF THE DRAWINGS

FIG. 1 is a vertical cross sectional view of a water purifying apparatus in a first embodiment in accordance with the present invention.

FIG. 2 is a view of a nozzle portion of the water purifying apparatus in the first embodiment in accordance with the present invention, seen from an exit side.

FIG. 3 is a vertical cross sectional view of the water purifying apparatus in the first embodiment in accordance with the present invention, of a type having an air intake tube.

FIG. 4 is a view of the nozzle portion and the air intake tube of the water purifying apparatus in the first embodiment in accordance with the present invention, of the type having an air intake tube, seen from an exit side.

FIG. 5 is a view of a nozzle portion of a water purifying apparatus in a second embodiment in accordance with the present invention, seen from an exit side.

FIG. 6 is a view of the nozzle portion and an air intake tube of the water purifying apparatus in the second embodiment in accordance with the present invention, of a type having an air intake tube, seen from an exit side.

FIG. 7 is an enlarged fragmentary view of FIG. 6.

FIG. 8 is a view of a nozzle portion of a water purifying apparatus in a third embodiment in accordance with the present invention, seen from an exit side.

FIG. 9 is a view of the nozzle portion and an air intake tube of the water purifying apparatus in the third embodiment in accordance with the present invention, of a type having an air intake tube, seen from an exit side.

FIG. 10 is a view of a nozzle portion of a modification of the water purifying apparatus in the third embodiment in accordance with the present invention, seen from an exit side.

FIG. 11 is a view of the nozzle portion and an air intake tube of the modification of the water purifying apparatus in the third embodiment in accordance with the present invention, of a type having an air intake tube, seen from an exit side.

### DESCRIPTION OF THE REFERENCE SIGNS

1 entry side cylindrical portion, 2 intermediate cylindrical portion, 3 exit side cylindrical portion, 4 tubular portion, 5 nozzle portion, 6 air intake hole, 7, 8 water pipes, 9 wall, 10 nozzle opening, 11 inlet, 12 outlet, 13 air mixing chamber, 14 air intake tube, 15 air outlet.

### BEST MODES FOR CARRYING OUT THE INVENTION

### First Embodiment

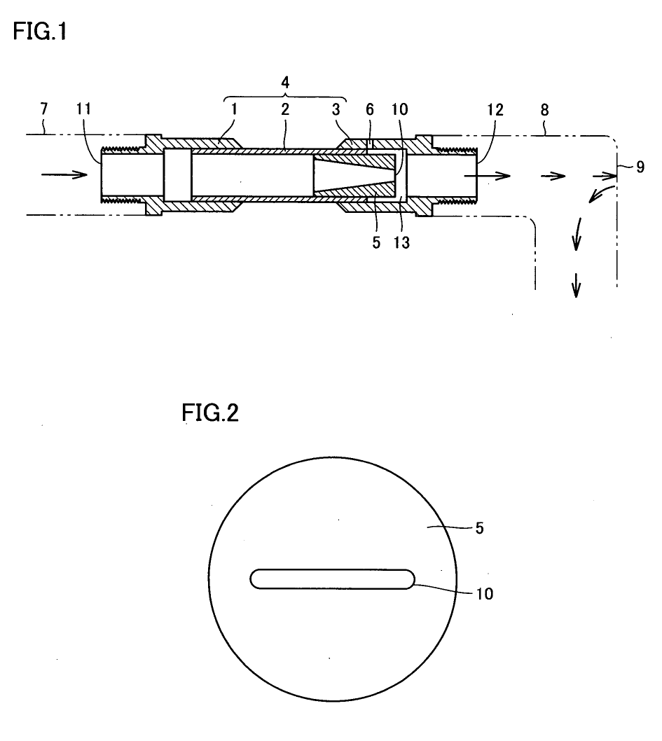

A water purifying apparatus in a first embodiment in accordance with the present invention will be described with reference to FIGS. 1 and 2. The water purifying apparatus includes a tubular portion 4, as shown in FIG. 1. Tubular portion 4 includes an entry side cylindrical portion 1, an intermediate cylindrical portion 2, and an exit side cylindrical portion 3. Tubular portion 4 has an inlet 11 for receiving water and an outlet 12 for emitting the water. Tubular portion 4 has an entry side connected to a water pipe 7 and an exit side connected to a water pipe 8.

Water to be purified is supplied from water pipe 7 toward tubular portion 4. The water flows into inlet 11 of entry side cylindrical portion 1. The water flowing from water pipe 7 has a flow produced by driving or pumping the water up to a higher level by a pump or the like (not shown) at a position within water pipe 7 or upstream of water pipe 7. In a case where the water within water pipe 7 has a flow produced by the power of nature even without using a pump or the like, no pump or the like is required.

This water purifying apparatus includes a nozzle portion 5 disposed inside tubular portion 4 to allow the water flowing through tubular portion 4 to pass therethrough. Nozzle portion 5 has a nozzle opening 10 for discharging the water toward outlet 12. Tubular portion 4 is provided with air supply means for mixing air taken in from outside tubular portion 4 with the water discharged from nozzle opening 10. The air supply means includes an air intake hole 6 and an air mixing chamber 13. Air intake hole 6 is a through-hole providing communication between the inside and the outside of tubular portion 4. Nozzle opening 10 has a shape defined by one line segment or a combination of a plurality of line segments. As shown in FIG. 2, nozzle opening 10 has a shape defined by one line segment. FIG. 2 shows nozzle portion 5 seen from the outlet side.

The function and effect of the example shown in FIG. 1 will be described. In this water purifying apparatus, water flowing from water pipe 7 into tubular portion 4 passes through nozzle portion 5. Since the water passes through nozzle opening 10 when it exists nozzle portion 5, it is discharged with its cross sectional shape having the shape of nozzle opening 10. When nozzle opening 10 has a shape as shown in FIG. 2, the water is discharged in the shape of a plate having a constant width. The discharged water passes straight through air mixing chamber 13, passes through outlet 12, and flows through the inside of water pipe 8. On this occasion, air is mixed with the water by the air supply means when the water passes through air mixing chamber 13. By mixing the air with the water, the amount of oxygen contained in the water is increased.

Preferably, water pipe 8 is bent in an L shape at a certain distance apart from outlet 12 to form a wall 9. Since nozzle opening 10 has a smaller opening area than that of inlet 11, the water has an intensified flow after it passes through nozzle opening 10, and then it collides with wall 9. The collision results in a smaller cluster of the water.

In this manner, the water emitted from water pipe 8 has a smaller cluster and contains an increased amount of oxygen. Consequently, the water purifying apparatus can purify water in a closed water area such as a pond, a lake, a marsh or a pool, or in a flowing water area such as a river or an irrigation channel.

Further, although a conventional structure has a problem that, when a larger nozzle is employed to increase the amount of water flow, the flow of the discharged water becomes wider and air cannot fully be mixed with the water just by being introduced close to the water, in the present embodiment, the nozzle opening has a shape defined by one line segment, and thus it can deal with an increase in the amount of water flow by having a long line segment. Furthermore, even when the amount of water flow is increased, the discharged water passes through air mixing chamber 13 not as a flow in the shape of a thick pillar but as a flow in the shape of a flat plate. In air mixing chamber 13 of the water purifying apparatus, since the water flows in the shape of a flat plate, the water has an increased surface area per volume, facilitating the mixing of the air introduced by the air supply means with the water. Consequently, the mixing of the air with the water can be performed without any difficulty even when a larger nozzle is employed, and the water can be purified as a result.

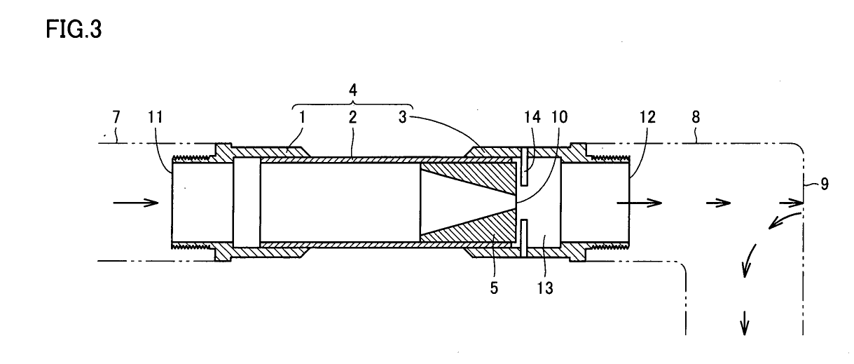

It is to be noted that the air supply means provided to the water purifying apparatus is not limited to the example shown in FIG. 1. Other than the example shown in FIG. 1, it may be, for example, the one as shown in FIG. 3. In the example shown in FIG. 3, the air supply means includes an air intake tube 14. One end of air intake tube 14 is in communication with a space outside tubular portion 4, and the other end of air intake tube 14 is located close to nozzle opening 10.

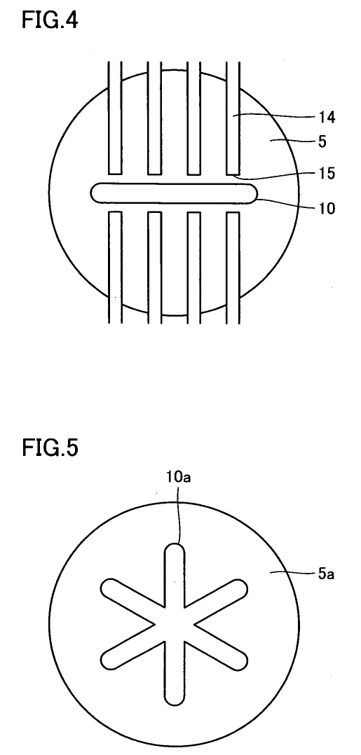

In this case, it is desirable to dispose air intake tube 14 corresponding to the shape of nozzle opening 10 as shown in FIG. 4. Preferably, the air supply means has an air outlet 15 closely facing the line segment constituting nozzle opening 10. In particular, it is preferable that air outlet 15 perpendicularly faces the line segment constituting nozzle opening 10 as shown in FIG. 4.

### Second Embodiment

A water purifying apparatus in a second embodiment in accordance with the present invention will be described with reference to FIG. 5. The water purifying apparatus in the present embodiment is basically the same as the one described in the first embodiment except that the shape of the nozzle opening or the like.

The water purifying apparatus is of a type having air intake hole 6 as in the example shown in FIG. 1, and includes a nozzle portion 5a instead of nozzle portion 5 described in the first embodiment. Nozzle portion 5a has a nozzle opening 10a. Nozzle opening 10a has a shape defined by radially combining not less than two line segments as shown in FIG. 5. While it has a shape defined by radially combining three line segments in the example shown in FIG. 5, some other number of the line segments may be used. Further, although the line segments are combined to have an equal angle therebetween in the example shown in FIG. 5, the angle between the combined line segments is not limited to an equal angle.

In a case where the nozzle opening has the shape described in the first embodiment, when an attempt is made to deal with an increase in water flow, there is no other choice than to lengthen the line segment, and thus the cross sectional shape of the nozzle portion itself should be enlarged, or extended in a width direction. In contrast, in the water purifying apparatus of the present embodiment, nozzle opening 10a is formed to have a shape defined by radially combining a plurality of line segments, and thus it can deal with an increase in water flow by increasing the number of the line segments to be combined as appropriate, without enlarging the cross sectional shape of the entire nozzle portion so much. Further, in the present embodiment, since the water passes through air mixing chamber 13 as a flow in the shape of combined flat plates corresponding to the line segments constituting nozzle opening 10a, the water has an increased surface area per volume, facilitating the mixing of the air introduced by the air supply means with the water. Consequently, the mixing of the air with the water can be performed without any difficulty even when a larger nozzle is employed.

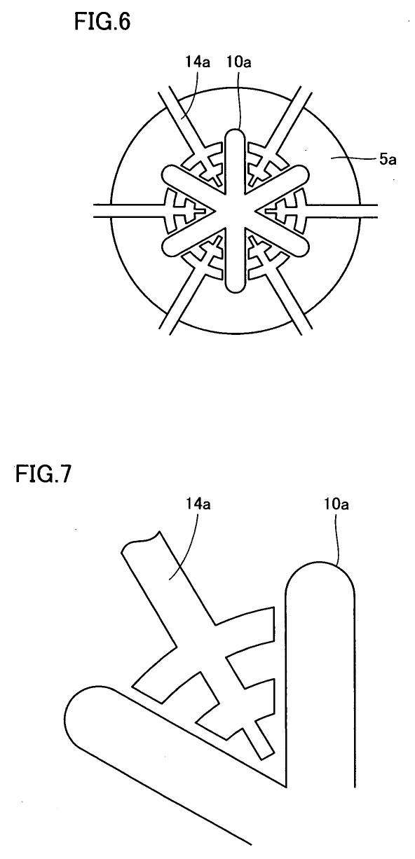

It is to be noted that the concept of the present embodiment can be applied to a water purifying apparatus of a type having an air intake tube as the example shown in FIG. 3. In that case, an air intake tube 14a is disposed around nozzle opening 10a as shown in FIG. 6. FIG. 7 is an enlarged fragmentary view of FIG. 6. Also in this type, it is preferable that the air supply means has an air outlet closely facing each of the line segments constituting nozzle opening 10a. In particular, it is preferable that the air outlet, that is, the end of air intake tube 14a faces each of the line segments constituting nozzle opening 10a as perpendicularly as possible, as shown in FIGS. 6 and 7. By providing air intake tube 14a in this manner, air can be introduced more reliably to each portion of the flow of the water discharged from nozzle opening 10a, and mixed with the water. In particular, it is preferable that the air outlet of air intake tube 14a is introduced into a detailed portion of nozzle opening 10a, such as a branched portion close to the center thereof, such that it enters a gap. Preferably, the end of air intake tube 14a is branched as shown in FIGS. 6 and 7 to introduce air to each portion of the flow of the discharged water. With this structure, the air can reliably be mixed with the discharged water.

In the present embodiment, even when a larger nozzle is employed, air can fully be mixed with water as described above to produce water having a large amount of oxygen contained therein, and thus the water can be purified sufficiently.

### Third Embodiment

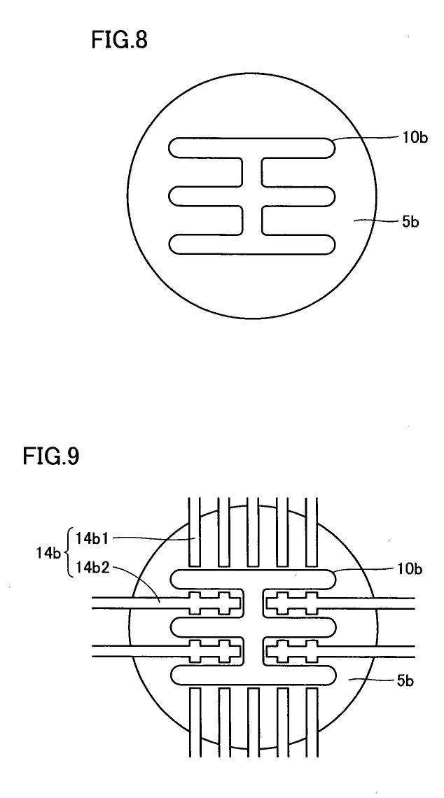

A water purifying apparatus in a third embodiment in accordance with the present invention will be described with reference to FIG. 8. The water purifying apparatus in the present embodiment is basically the same as the one described in the first embodiment except that the shape of the nozzle opening or the like.

The water purifying apparatus is of a type having air intake hole 6 as in the example shown in FIG. 1, and includes a nozzle portion 5b instead of nozzle portion 5 described in the first embodiment. Nozzle portion 5b has a nozzle opening 10b. Nozzle opening 10b has a shape including not less than two line segments disposed in parallel as shown in FIG. 8. While it has a shape defined by combining three parallel line segments and one line segment orthogonal to these three line segments in the example shown in FIG. 8, some other number of the line segments may be used. Further, the arrangement of the line segments is not limited to the one shown in FIG. 8, and some other arrangement may be used.

In the water purifying apparatus of the present embodiment, nozzle opening 10b is formed to have a shape including not less than two line segments disposed in parallel, and thus it can deal with an increase in water flow by increasing the number of the line segments to be combined as appropriate, without enlarging the cross sectional shape of the entire nozzle portion so much. Further, in the present embodiment, since the water passes through air mixing chamber 13 as a flow in the shape of combined flat plates corresponding to the line segments constituting nozzle opening 10b, the water has an increased surface area per volume, facilitating the mixing of the air introduced by the air supply means with the water. Consequently, the mixing of the air with the water can be performed without any difficulty even when a larger nozzle is employed.

It is to be noted that the concept of the present embodiment can be applied to a water purifying apparatus of a type having an air intake tube as the example shown in FIG. 3. In that case, an air intake tube 14b is disposed around nozzle opening 10b as shown in FIG. 9. Details of air intake tube 14b such as its disposition and preferable conditions are the same as those described for air intake tube 14a in the second embodiment.

In the present embodiment, even when a larger nozzle is employed, air can fully be mixed with water as described above to produce water having a large amount of oxygen contained therein, and thus the water can be purified sufficiently.

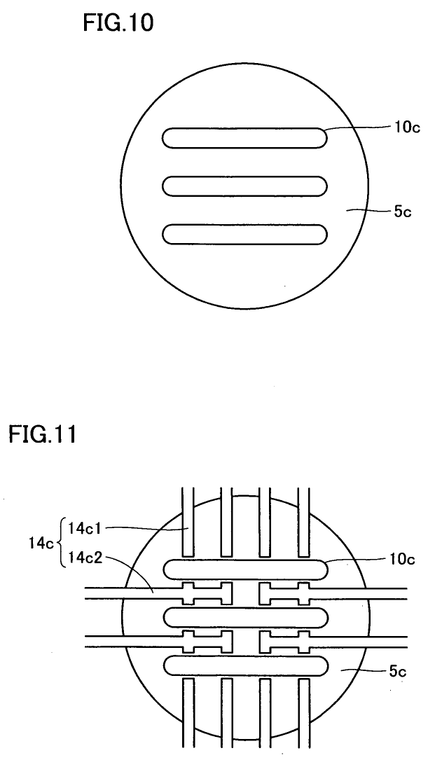

Further, as a modification of the example shown in FIG. 8, the water purifying apparatus may be provided with a nozzle portion 5c having a nozzle opening 10c in the shape including not less than two line segments disposed in parallel as shown in FIG. 10. Some other number of the line segments may be used. While all the line segments have an equal length and are disposed in parallel at equally spaced intervals in the example shown in FIG. 10, all the line segments do not have to have an equal length, and they may be disposed at intervals other than equally spaced intervals.

For the example shown in FIG. 10, an air intake tube can be disposed as shown in FIG. 11, which shows an example derived from FIG. 9 corresponding to the modification. In that case, the water purifying apparatus is provided with nozzle portion 5c having nozzle opening 10c as shown in FIG. 11. An air intake tube 14c is disposed around nozzle opening 10c. Details of air intake tube 14c such as its disposition and preferable conditions are the same as those described for air intake tube 14a in the second embodiment. The effect of the present invention can also be achieved in these examples.

It is to be noted that, although each of the above embodiments describes a case where tubular portion 4 includes three portions, specifically, entry side cylindrical portion 1, intermediate cylindrical portion 2, and exit side cylindrical portion 3, tubular portion 4 may be an integral piece. Although each of the above embodiments describes a case where nozzle portion 5, which is a separate piece, is fit and disposed inside tubular portion 4, the tubular portion and the nozzle portion may be formed integrally.

Some sort of a casing may be provided outside tubular portion 4. In that case, the outer end of air intake hole 6 or air intake tube 14 does not have to be open directly to the outside of the casing, and it may be open to the inside of the casing.

Although tubular portion 4 and nozzle portion 5 have a circular transverse cross sectional shape in each of the above embodiments, they may have a transverse cross sectional shape other than a circular shape.

It should be understood that the above embodiments disclosed herein are, in all respects, by way of illustration only and are not by way of limitation. The scope of the present invention is set forth by the claims rather than the above description and is intended to cover all the modifications within a spirit and scope equivalent to those of the claims.

### INDUSTRIAL APPLICABILITY

The present invention is applicable to a water purifying apparatus for purifying water in a closed water area such as a pond, a lake, a marsh or a pool, or in a flowing water area such as a river or an irrigation channel.

1. A water purifying apparatus, comprising:
a tubular portion having an inlet for receiving water and an outlet for emitting the water, and
a nozzle portion disposed inside said tubular portion to allow the water flowing through said tubular portion to pass therethrough,
wherein said nozzle portion has a nozzle opening for discharging the water toward said outlet,
said tubular portion is provided with air supply means for mixing air taken in from outside said tubular portion with the water discharged from said nozzle opening, and
said nozzle opening has a shape defined by one line segment or a combination of a plurality of line segments.

2. The water purifying apparatus according to claim 1, wherein said nozzle opening has a shape defined by radially combining not less than two line segments.

3. The water purifying apparatus according to claim 1, wherein said nozzle opening has a shape including not less than two line segments disposed in parallel.

4. The water purifying apparatus according to claim 1, wherein said air supply means has an air outlet closely facing each said line segment constituting said nozzle opening.

5. The water purifying apparatus according to claim 4, wherein said air outlet perpendicularly faces each said line segment constituting said nozzle opening.
